(19) United States
(12) Patent Application Publication
(10) Pub. No.: US 2011/0049018 A1
(43) Pub. Date: Mar. 3, 2011

(54) MINE SCREEN

(75) Inventor: Petrus Marthinus BEUKES, Bronkhorspruit (ZA)

(73) Assignee: ALLAN MASKEW (PTY) LTD, Gauteng (ZA)

(21) Appl. No.: 12/871,126

(22) Filed: Aug. 30, 2010

(30) Foreign Application Priority Data
Aug. 28, 2009 (ZA) 2009/06011

(51) Int. Cl. B07B 1/46

(52) U.S. Cl. 209/405; 209/408

(57) ABSTRACT

In a mine screen used for separating materials, a reinforcement frame includes an elongate body shaped and dimensioned to correspond to the perimeter of the mine screen. The elongate body includes at least one circular metal bar. The elongate body may include at least one cross member extending from one side of the perimeter to another side of the perimeter, and the elongate body may be shaped as an equiangular quadrilateral or equilateral.

This invention relates to a mine screen. In particular, the invention relates to a reinforcement frame and to a screen.

### BACKGROUND OF THE INVENTION

The inventors are aware of mine screens used for separating materials. Screens are typically moulded from mouldable materials and are sometimes reinforced with metal bars. However, when the screens are worn the moulded portions may separate from the reinforced metal bars, causing damage to equipment when undesired materials mix.

### SUMMARY OF THE INVENTION

According to one aspect of the invention, there is provided a reinforcement frame, which includes

an elongate body shaped and dimensioned to correspond to a perimeter of a mine screen, the elongate body being defined by at least one circular metal bar.

The elongate body may define at least one cross member extending from one side of the perimeter to another side of the perimeter.

The elongate body may be shaped to define an equiangular quadrilateral. The elongate body may be equilateral. For example, the elongate body may be roughly square shaped or rectangular shaped.

The circular metal bar may be of steel. In particular, the circular metal bar may be of an alloy having strong yield strength such as spring steel. For example, the circular metal bar may be of spring steel wire. The circular metal bar may have a diameter of between 3 mm to 15 mm.

In one embodiment, the elongate body may be defined by at least two metal bars, arranged on top of each other to define a reinforcement beam. For example, the metal bars may be welded together on top of each other. It is to be appreciated that the elongate body may be defined by multiple metal bars.

According to another aspect of the invention, there is provided a screen, which includes

a moulded screen; and
a reinforcement frame, as hereinbefore described, moulded into the screen.

In one embodiment, the moulded screen may be defined by a moulded peripheral frame defining a frame opening through the frame, with an integrally moulded, aperture screen defined within the frame opening.

The moulded peripheral frame may be in the form of an equiangular quadrilateral. The frame may be equilateral.

The moulded peripheral frame may be operatively upright rectangular in section to define a peripheral reinforcement beam.

The moulded screen may include at least one cross member extending across the frame opening.

The reinforcement frame may be moulded into the moulded frame. In particular, the reinforcement frame may be moulded into the frame at a position proximate the operative lower part of the operatively upright rectangular section of the peripheral reinforcement beam.

Advantageously, with the operative upright rectangular section of the peripheral reinforcement beam, the reinforcement frame may be constructed from at least two metal bars so as to provide a rigid beam whilst maintaining a narrow profile in the peripheral reinforcement beam. The narrow profile of the reinforcement beam maximizes the area of the frame opening. Furthermore, in use, due to its cross-sectioned shape, the reinforcement frame is mechanically bound to the moulded peripheral frame, thereby resisting separation from the moulded peripheral frame when the frame is worn away.

The invention will now be described, by way of example only with reference to the following drawing.

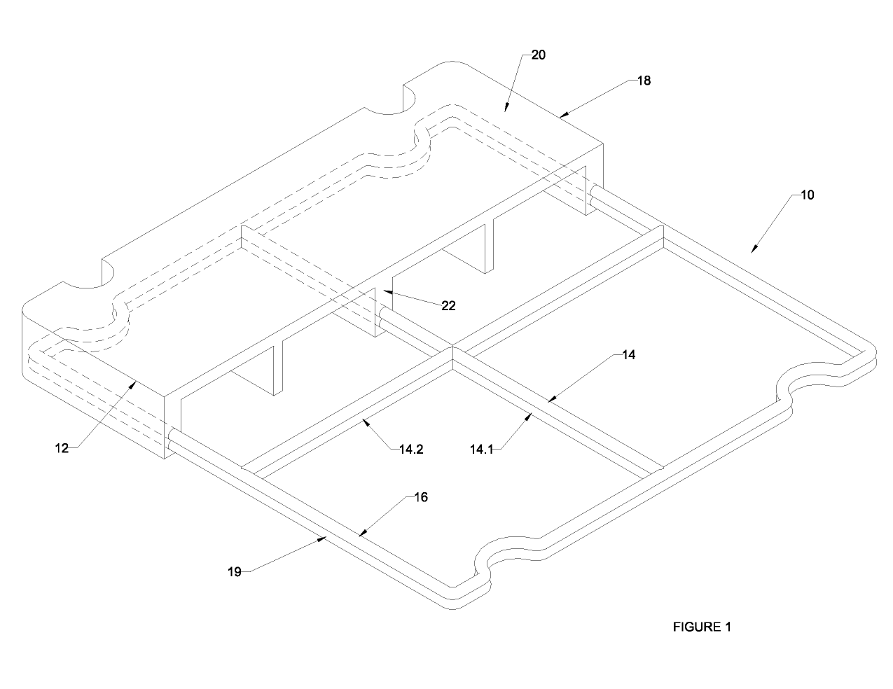

FIG. 1 shows a composite three-dimensional drawing of a reinforcement frame, moulded into a moulded mine screen, both in accordance with the invention.

### EMBODIMENT OF THE INVENTION

In FIG. 1 reference numeral 10 refers to a reinforcement frame in accordance with the invention. Reference numeral 12 refers to a mine screen, shown in broken lines for clarity, also in accordance with the invention.

The reinforcement frame 10 has an elongate body 14 and dimensioned in the form of an equiangular, equilateral quadrilateral to correspond with the perimeter of the mine screen 12. In this example, the elongate body is roughly square shaped.

The elongate body 14 is defined by two circular metal bars 16, 17 welded on top of each other. The elongate body 14 defines two cross members 14.1, 14.2 extending from opposed sides of the quadrilateral.

The two circular metal bars 16, 17 are of an alloy having a strong yield strength such as spring steel. In this example, the circular metal bars have diameters of 5 mm. However, depending on the required application and construction, the metal bars may have diameters of between 3 mm to 15 mm.

The mine screen 12 is moulded onto the reinforcement frame 14. Only a portion of the moulded screen 12 is shown to illustrate the position of the reinforcement frame 10 in the screen 12.

As can be seen, the reinforcement frame 10 corresponds with the periphery of the screen 12.

The screen 12 is defined by a moulded peripheral frame 18 is roughly square shaped. It is to be appreciated that the size and dimensions of the screen 12 will depend on the configuration in a particular application.

As illustrated in FIG. 1, the peripheral frame 18 is operatively upright rectangular in section to define a peripheral reinforcement beam. The reinforcement frame 10 forms part of the reinforcement beam, being moulded into the frame 18 at a position proximate the operative lower part of the operatively upright rectangular section of the peripheral reinforcement beam. The reinforcement frame 10 is mechanically bound to the moulded peripheral.

1. A reinforcement frame including an elongate body shaped and dimensioned to correspond to the perimeter of a mine screen, the elongate body comprising at least one circular metal bar.

2. A reinforcement frame according to claim 1 in which the elongate body includes at least one cross member extending from one side of the perimeter to another side of the perimeter.

3. A reinforcement frame according to claim 2 in which the elongate body is shaped to comprise an equiangular quadrilateral.

4. A reinforcement frame according to claim 3 in which the elongate body is equilateral.

5. A reinforcement frame according to claim 1 in which the circular metal bar is a steel bar.

6. A reinforcement frame according to claim 5 in which the circular metal bar is of a steel alloy having a strong yield strength.

7. A reinforcement frame according to claim 6 in which the circular metal bar is of sprung steel.

8. A reinforcement frame according to claim 1 in which the circular metal bar has a diameter of between 3 mm and 15 mm inclusive.

9. A reinforcement frame according to claim 1 in which the elongate body comprises a plurality of metal bars.

10. A reinforcement frame according to claim 9 in which the elongate body comprises at least two metal bars, arranged on top of each other to define a reinforcement beam.

11. A reinforcement frame according to claim 10 in which the metal bars are welded together on top of each other.

12. A screen, including a moulded screen and a reinforcement frame as claimed in claim 1, in which the frame is moulded into the screen.

13. A screen according to claim 12 in which the moulded screen comprises a moulded peripheral frame defining an opening through the frame and an integrally moulded aperture screen defined with the frame.

14. A screen according to claim 13 in which the moulded peripheral frame is in the form of an equiangular quadrilateral.

15. A screen according to claim 14 in which the moulded peripheral frame is equilateral.

16. A screen according to claim 14 in which the moulded peripheral frame is operatively upright rectangular in section to define a peripheral reinforcement beam.

17. A screen according to claim 12 in which the moulded screen includes at least one cross member extending across the frame opening.

18. A screen according to claim 13 in which the reinforcement screen is moulded into the moulded peripheral frame.

19. A screen according to claim 18 in which the reinforcement screen is moulded into the moulded peripheral frame at a position proximate the lower part of the operatively upright rectangular section of the peripheral reinforcement beam.

20. A reinforcement frame according to claim 2 in which the circular metal bar has a diameter of between 3 mm and 15 mm inclusive.
